(19) United States
(12) Patent Application Publication
(10) Pub. No.: US 2008/0213500 A1
(43) Pub. Date: Sep. 4, 2008

(54) Method for Producing Electrode Material

(75) Inventors: Hidenori Uchi, Tokyo (JP); Kenji Tamamitsu, Tokyo (JP); Satori Tsumeda, Tokyo (JP); Alexander M. Timonov, Saint Petersburg (RU); Sergey Nikolay Shkolnik, West Hartford, CT (US); Sam Kogan, Newton Center, MA (US)

Correspondence Address: PILLSBURY WINTHROP SHAW PITTMAN, LLP, P.O. BOX 10500, MCLEAN, VA, 22102, US

(73) Assignees: NIPPON CHEMI-CON CORPORATION, Tokyo (JP); GEN3PARTNER, INC., Boston, MA (US)

(21) Appl. No.: 11/664,286

(22) PCT Filed: Sep. 30, 2004
(86) PCT No.: PCT/JP2004/014767

§ 371 Date: Mar. 14, 2008

(51) Int. Cl. C08F 2/58

(52) U.S. Cl. 427/487

(57) ABSTRACT

To provide a method for producing an electrode material which is improved in energy density and is excellent in output characteristics. The present invention provides a manufacturing method for the electrode material comprising the steps of: 1) immersing a conductive material having a specific surface area of 200 to 3000 m²g⁻¹ in a complex monomer solution of a transition metal having at least two different oxidation numbers, 2) performing electro polymerization by applying pulse voltage using the conductive material as an electrode to stack the complex monomer under the condition that electrolyzation time is 0.1 to 60 second and a downtime is 10 to 600 second, and 3) forming on the surface of the conductive material an energy accumulating redox polymer layer containing polymer complex compound of transition metal formed by the stacked complex monomer, thereby accumulating energy via a redox reaction: wherein a thin and uniform electrode film is formed, namely the electrode material which is excellent in output characteristics and improves energy density is manufactured according to the method.

### FIELD OF THE INVENTION

The present invention relates to a method for producing an electrode material and for more detail, relates to a method for producing the electrode material in which energy density is improved and which is excellent in output characteristics.

### BACKGROUND OF THE INVENTION

In these years, an electric automobile and hybrid car have been expected instead of a gasoline-powered vehicle and diesel-powered vehicle which are engine-driven. In these electric automobile and hybrid car, an electrochemical device having high energy density and high output density properties are used as a power source for driving a motor. A secondary battery and a double electric layer capacitor are listed as this electrochemical device.

As the secondary battery, a lead battery, nickel/cadmium battery, nickel hydride battery, or proton battery and so on are listed. These secondary battery uses acidic or alkaline aqueous electrolyte solution which are high in ionic conductivity, thereby to have excellent output characteristics that large electric current is obtained when charging and discharging, however electrolysis voltage of water is 1.23V, therefore higher voltage may not be obtained. As a power source of the electric automobile, a high voltage of approximately 200V is required, therefore many batteries by just that much must be connected in series, resulting in disadvantage for downsizing and trimming weight of the power source.

As a secondary battery of high voltage type, a lithium ion secondary battery using organic electrolyte solution is known. This lithium ion secondary battery uses an organic solvent with high decomposition voltage as an electrolytic solvent, therefore when the lithium ion showing the lowest potential is an electric charge relating to charge/discharge reaction, potential of 3V or more is shown. The lithium ion secondary battery brings a battery using carbon as a negative electrode occluding and releasing the lithium ion and cobalt acid lithium (LiCoO₂) as a positive electrode into mainstream. An electrolyte solution dissolving lithium salt such as hexafluorophosphate lithium (LiPF₆) into a solvent such as ethylene carbonate and propylene carbonate is used.

However, this lithium ion secondary battery is high in voltage and high in energy density to be excellent as a power source, however charge reaction is occlusion and release of the lithium ion of the electrode, therefore the secondary battery has a problem to be inferior in output characteristics, which is a disadvantage for the power source for the electric automobile requiring large instantaneous current. Then, there is an approach using derivative of polythiophene as a positive electrode for improving the charge/discharge property at a high voltage (Japanese Laid-Open Patent Publication No. 2003-297362).

An double electric layer capacitor uses a polarizable electrode such as activated carbon as positive and negative electrodes, and uses a solution dissolving quaternary onium salt of boron tetrafluoride or phosphorus hexafuoride into an organic solvent such as propylene carbonate. Thus, the double electric layer capacitor regards an double electric layer generating at the boundary surface between the surface of the electrode and the electrolyte solution as an electric capacitance, and there is no reaction involving ions such as a battery, thus the charge/discharge property is high and deterioration in capacity due to charge/discharge cycle is reduced. However, energy density due to double layer capacity is low in the energy density compared to the battery, that is significantly insufficient as a power source of the electric automobile. At the same time, there is an approach using polypyrrole as a positive electrode for the purpose of large capacity (Japanese Laid-Open Patent Publication No. H6-104141).

Then, an electrochemical capacitor using conductive polymer and metal oxide as an electrode material which is high in energy density and high in output characteristics has been developed. An electric charge storage mechanism of this electrochemical capacitor is adsorption and desorption of anion and cation in the electrolyte solution onto the electrode, and both energy density and output characteristics are excellent. Particularly, an electrochemical capacitor using conductive polymer such as polyaniline, polypyrrole, polyacene, and polythiophene derivatives performs charge and discharge by p-doping or n-doping of anion or cation in non-aqueous electrolyte solution onto the conductive polymer. The potential of this doping is low at a side of negative electrode and high at a side of positive electrode, therefore high voltage property is obtained (Japanese Laid-Open Patent Publication No. 2000-315527).

However, the capacitor using the above conductive polymer was also desired to improved energy density and out put characteristics. In order to comply with the above desire, an energy storage device, such as a battery or super capacitor, is developed that includes at least two electrodes, at least one of the electrodes includes an electrically conducting substrate having a layer of energy accumulating redox polymer complex compound of transition metal having at least two different degrees of oxidation, which polymer complex compound is formed of stacked transition metal complex monomers. In the energy storage device, the stacked transition metal complex monomers have a planar structure with the deviation from the plane of no greater than 0.1 nm and a branched system of conjugated pi-bonds, the polymer complex compound of transition metal can be formed as a polymer metal complex with substituted tetra-dentate Schiff's base, and the layer thickness of redox polymer is within the range 1 nm-20 m (International Patent Publication No. WO03/065536). Further, the above polymer complex compound may be used for both positive and negative electrodes since it's central metal could be reversibly oxidized-reduced. The capacitor using these electrodes as the both electrodes allows to have a high operating voltage of 3V and a high energy density of 300 Jg⁻¹, and a method for producing it by which this energy density is obtained is also described (International Patent Publication No. WO 04/030123).

### SUMMARY OF THE INVENTION

### Problems to Be Solved by the Invention

However, demand for downsizing for the use of power source of an electric automobile and so on is constant, therefore there is a strong demand for enhanced energy density and enhanced output characteristics. Then, an object of the present invention is to provide a manufacturing method of an electrode material having an high energy density and excellent output characteristics.

### Means for Solving the Problems

The present invention has had discussions on a method for producing electrode material to solve the above problems. Consequently, the present invention provides a method for forming a thin and uniform electrode film through a method for producing the electrode material comprising the steps of 1) immersing a conductive material having a specific surface area of 200 to 3000 m²g⁻¹ in a complex monomer solution of a transition metal having at least two different oxidation numbers, 2) performing electrolysis polymerization by applying pulse voltage using the conductive material as an electrode to stack the complex monomer under the condition that electrolyzation time is 0.1 to 60 second and a downtime is 10 to 600 second, and 3) forming on the surface of the conductive material an energy accumulating redox polymer layer containing polymer complex compound of transition metal formed by the stacked complex monomer, thereby accumulating energy via redox reaction.

### EFFECT OF THE INVENTION

The present invention enables thin and uniform coating of the surface of an electrode structure of metal, carbon and so on with polymer complex compound of transition metal, namely enables an increase of surface area compared to film thickness, consequently the electrode material prepared by the present method increases ratio of doping and dedoping per unit volume against films of anion and cation, and achieves improvement of rate property and cycle property, resulting in an electrochemical device use electrode material having high power properties. The electrode material prepared as described above is also possible to form the electrode film without blocking hole portions of porous material, therefore surface area is increased and energy density is improved. As a result, an electrochemical device use electrode material which is excellent in output characteristics and high energy density can be obtained.

### BRIEF DESCRIPTION OF THE DRAWINGS

FIG. 1. is a schematic view showing a stacked state of polymer metal complex.

FIG. 2. a) is a schematic view showing polymer metal complex in an oxidized state bonded on electrode surface by chemical adsorption,

b) is a schematic view showing polymer metal complex in a reduced state bonded on the electrode surface by the chemical adsorption.

FIG. 3. a) is a schematic view when polymer metal complex is in a neutral state,

b) is a schematic view when polymer metal complex is in an oxidized state.

### DETAILED DESCRIPTION OF THE INVENTION

In order to enhance the energy density of the polymer complex compound of transition metal, it is necessary to optimize a large variety of parameters relating to the electro polymerization. In particular, it is desired to optimize the electrolysis time, the downtime and the polymerization charge. In addition, as a result of study about a improvement in the energy density of said electrode, not only these parameters but also a specific surface area of the electrode substrate influences on the enhancement of energy density. In the suitable characteristics, the specific surface area of the electrode substrate preferably may be 200 to 3000 m²g⁻¹, more preferably 1000 to 3000 m²g⁻¹, further more preferably 1500 to 2500 m²g⁻¹. Further, the electro polymerization on this substrate may be performed under the following condition of the electrolysis time, the downtime, the polymerization charge and the number of pulse. Namely, the electrolysis time may be 0.1 to 60 second, preferably 0.5 to 10 second, more preferably 0.7 to 5 second. The downtime may be 10 to 300 second, preferably 10 to 60 second, more preferably 20 to 30 second. Accordingly, a pulse ratio, which defines as a proportion of a pulse repetition time (the electrolysis time+the downtime) to the electrolysis time, is less than 1500, preferably less than 60, and less than 30. When the electro polymerization is performed to the electrode substrate having high-specific surface area characteristics within these ranges, the optimal conditions for the diffusion and the polymerization of the complex monomer oxidized during the electrolytic times into the holes of the substrate or the defects formed in the polymer could be obtained, thereby forming a thin polymer film and as the result the electrode having a high energy density could efficiently be produced. As to the downtime, down-state means that value of the electric potential becomes the value at which the polymerization of the monomer stops. Such value of the electric potential may be −2 to +0.5 V, preferably −1 to +0.3 V, more preferably −0.5 to 0 V.

Then, manufacturing process of polymer complex compound of transition metal and an electrode using the polymer complex compound of transition metal according to an embodiment of the present invention will be described. At first, an electrode coated on an electric collector plate with carbon or metal structure is regarded as a work electrode, which is immersed in dissolved electrolyte solution of complex monomer, and an activated carbon electrode is regarded as a counter electrode, then an electro polymerization is performed by applying a constant electric potential to a reference electrode to obtain the polymer complex compound of transition metal from the complex monomer.

Thus, electrolyte solution dissolving the complex monomer is used, thereby elution of the complex monomer into the electrolyte solution during polymerization is suppressed, while polymerization of the complex monomer dissolved into the electrolyte solution is enabled, resulting in achieving improvement of an amount of polymerization per unit time and unit square measure.

Also a manufacturing process method of polymer complex compound of transition metal and an electrode using the polymer complex compound of transition metal according to another embodiment of the present invention comprises the steps of: stacking a film comprising a mixture of the above complex monomer and conductive auxiliary substance on the electric collector plate to perform film forming; thereafter drying the same to form an electrode; immersing this electrode into an electrolyte solution; performing an electro polymerization by applying a constant level of electric potential to a reference electrode in the use of an activated carbon electrode as a counter electrode, thereby to obtain the polymer complex compound of transition metal.

This polymer complex compound of transition metal is formed as an electrode comprising a film formed on the surface of the electric collector plate, thus that may be used as a constituent of device for battery, capacitor and so on without any process. Therefore, an electrode containing the polymer complex compound of transition metal may be obtained in a simple and short process.

In addition, in the electro polymerization of the present invention, polymerization is performed by immersing the above electrode into the electrolyte solution and applying an oxidation potential of the complex monomer to the reference electrode with using the activated carbon electrode as a counter electrode or flowing oxidation current, however not only such a triple pole type but also double pole type may be used.

The electrolyte solution dissolving the complex monomer used for the electro polymerization of the present invention may use as a solvent therefore a solvent of which solubility of the complex monomer is 0.01 to 50 wt %, more preferably 0.01 to 10 wt %. When the solubility is higher than this value, the complex monomer becomes easy to elute into the electrolyte solution, the complex monomer fixed and condensed on the electric collector plate decreases, thereby efficiency of the manufacturing is down. Meanwhile, when the solubility is lower than this value, namely when the electro polymerization is performed in the electrolyte solution using the solvent in which the complex monomer is almost insoluble, polymerization characteristics of the complex monomer is lowered, thereby excellent polymer complex compound of transition metal may not be obtained. By using the electrolyte solution having the solubility in the above range, improvement in yield of polymer complex compound of transition metal may be achieved without elution of the complex monomer or the formed polymer complex compound of transition metal more than necessary from the electrode. In addition, the solvent of the electrolyte solution dissolving the complex monomer is not limited to whether water or organic solvent as long as it is available.

As the electrolyte solution dissolving the complex monomer used for the electro polymerization of the present invention, a salt which is soluble in water of, for instance, alkaline metal salt, alkaline earth metal salt, organic sulphonate, sulphate salt, nitrate salt, perchlorate, and so on and which can ensure ions conductivity is preferably used as a supporting electrolyte solution in the case of aqueous solution and both the kind and concentration are not limited. Further, if required, protonic acid of the above salt may be used or another proton source may be added.

As electro polymerization mode, for instance, potential sweep polymerization method, constant potential polymerization method, constant current polymerization method, and potential step method as well as potential pulse method are listed, however in particular, the potential pulse method may be used in the present invention.

In the present invention, pulse voltage condition may be Ag/Ag+ of 0.5 to 1.0V, preferably Ag/Ag+ of 0.5 to 0.7V, more preferably Ag/Ag+ of 0.5 to 0.6V. If voltage is in this range, an enough amount of complex monomer oxide is formed through an electrochemical reaction, therefore the complex polymer compound of transition metal is formed efficiently, and further the formed complex polymer compound of transition metal is difficult to form peroxide, consequently complex polymer compound of high-capacity density transition metal is formed.

In the electro polymerization of the present invention, the number of cycle may be 100 to 10000 cycles, preferably 100 to 5000 cycles, more preferably 200 to 2000 cycles. If the number of cycle is in this range, an amount of production of the complex polymer compound of transition metal is enough, in addition, the complex polymer compound of transition metal is not produced excessively, therefore a thin film of the complex polymer compound of transition metal is maintained.

In the electro polymerization of the present invention, material ensuring conductivity such as carbon black, crystalline carbon, amorphous carbon may be used as a conductive auxiliary substance.

In the electro polymerization of the present invention, binder may be used for fixing the complex monomer and the conductive auxiliary substance on the electric collector plate. As a binder, organic resin material and so on such as, for instance, polyvinylidene fluoride is listed. Ratio of mixture of constituent material of these electrodes is arbitrary, however, when an amount of the complex monomer does not exist to some extent, manufacturing efficiency is lowered. If the binder is added too much, the electro polymerization is possible to be disturbed. Thus, the electrode may contain the complex monomer of 30 wt % or more of the total, preferably 40 wt % to 70 wt %, and the binder may contain 5 wt % to 10 wt %.

The polymer complex compound of transition metal obtained in the electro polymerization of the present invention may be the polymer metal complex of tetra-dentate Schiff's base, in particular, represented by the following graphical formula:

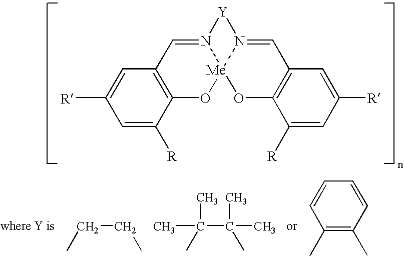

where Me is transition metal,
R is H or electron donating substituent,
R′ is H or halogen, and
n is an integer number of 2 to 200000.]
In particular, as preferable transition metal Me, Ni, Pd, Co, Cu, and Fe are listed. As preferable R, CH₃O—, C₂H₅O—, HO—, and —CH₃ are listed.

According to the principles of the present invention a redox polymer complex compound of transition metal is configured as “uni-directional” or “stack” macromolecules.

Representatives of the group of polymer metal suitable for the electrodes fall into the class of redox polymers, which provide novice anisotropic electronic redox conduction. For more detail on these polymer complexes, see Timonov A. M., Shagisultanova G. A., Popeko I. E. Polymeric Partially-Oxidized Complexes of Nickel, Palladium and Platinum with Schiff Bases//Workshop on Platinum Chemistry. Fundamental and Applied Aspects. Italy, Ferrara, 1991. P. 28.

Formation of bonds between fragments can be considered, in the first approximation, as a donor-acceptor intermolecular interaction between a ligand of one molecule and the metal center of another molecule. Formation of the so-called “unidimensional” or “stack” macromolecules takes place as a result of said interaction. Such a mechanism of the formation of “stack” structures of a polymer currently is best achieved when using monomers of square-planar spatial structure. Schematically this structure can be presented as follows

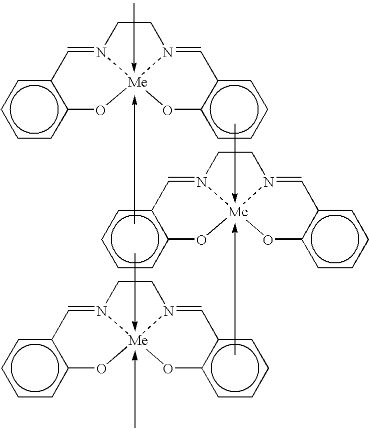

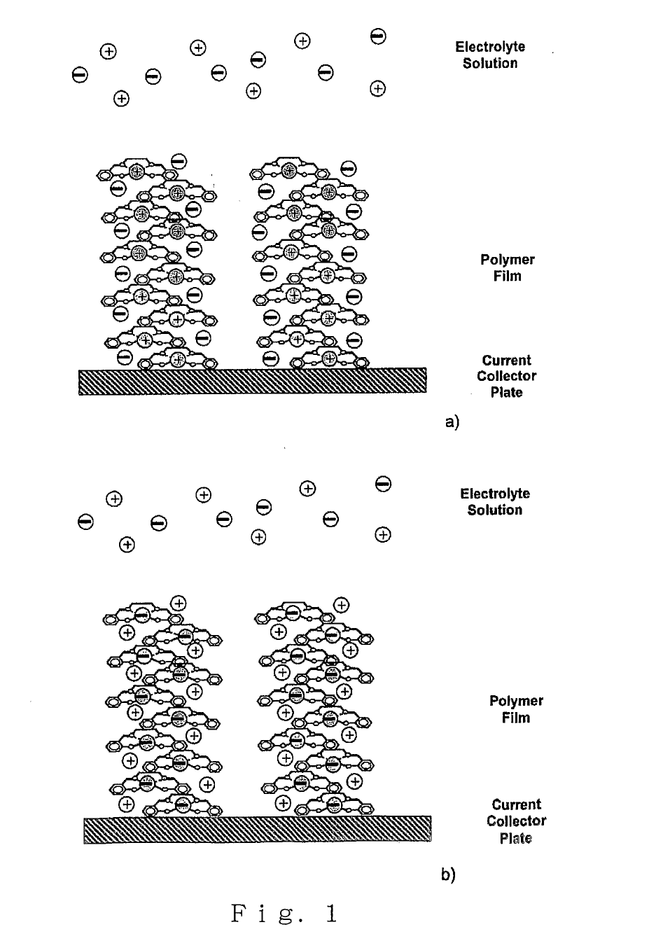

Superficially a set of such macromolecules looks to the unaided eye like a solid transparent film on an electrode surface. The color of this film may vary depending on the nature of metal and presence of substitutes in the ligand structure. But when magnified, the stack structures become evident, see FIG. 1.

Polymer metal complexes are bonded with the inter-electrode surface due to chemisorption.

Charge transfer in polymer metal complexes is effected due to “electron hopping” between metal centers with different states of charge. Charge transfer can be described mathematically with the aid of a diffusion model. Oxidation or reduction of polymer metal complexes, associated with the change in the states of charge of metal centers and with directed charge transfer over polymer chain, is accompanied, to maintain overall electrical neutrality of the system, by penetration into a polymer of charge-compensating counter-ions that are present in the electrolyte solution surrounding the polymer or by the egress of charge-compensating counter-ions from the polymer.

The existence of metal centers in different states of charge in a polymer metal complex is the reason for calling them “mixed-valence” complexes or “partially-oxidized” complexes.

The metal center in the exemplary polymer complex poly-[Ni(CH3O-Salen)] may be in one of three states of charge:

Ni²⁺-neutral state;

Ni³⁺-oxidized state;

Ni⁺-reduced state.

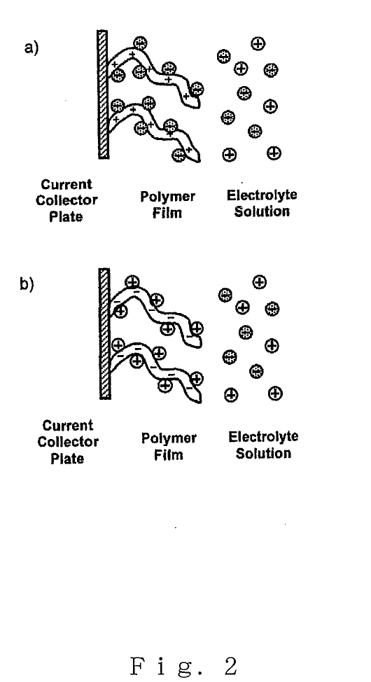

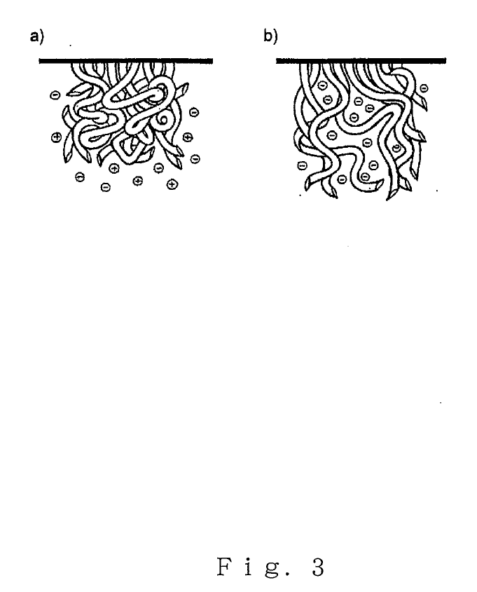

When this polymer is in the neutral state (FIG. 3a), its monomer fragments are not charged and the charge of the metal center is compensated by the charge of the ligand environment. When this polymer is in the oxidized state (FIG. 3b), its monomer fragments have a positive charge, and when it is in the reduced state, its monomer fragments have a negative charge. To neutralize spatial (volume) charge of a polymer when the latter is in the oxidized state, electrolyte anions are introduced into the polymer structure. When this polymer is in the reduced state, neutralization of the net charge results due to the introduction of cations (see FIG. 2). The electrode material of the present invention may use polymer metal complex in an oxidized state as a charged state of positive electrode and use a reduced state as a charged state of negative electrode. Therefore, the electrode material of the present invention is allowed to be used for both positive and negative electrodes.

An electrochemical device using the above electrode and the below electrolyte solution may be formed. The used electrolyte solution may be non-aqueous type and aqueous type. When using a non-aqueous electrolyte solution, a solvent preferably contains one or more substances selected from a group constituted of ethylene carbonate, propylene carbonate, butylene carbonate, dimethyl carbonate, ethylmethyl carbonate, diethyl carbonate, sulphorane, acetonitrile, and dimethoxy ethane. As a solute, lithium salt having the lithium ion, quaternary ammonium salt or quaternary phosphonium salt having quaternary ammonium cation or quaternary phosphonium cation respectively may be listed. As lithium salt, LiPF₆, LiBF₄, LiClO₄, LiN(CF₃SO₂)₂, LiCF₃SO₃, LiC(SO₂CF₃)₃, LiAsF₆ and LiSbF₆ and so on are listed. Also as quaternary ammonium salt or quaternary phosphonium salt, a salt comprising cation expressed by R1R2R3R4N+ or R1R2R3R4P+ (where R1, R2, R3, R4 are alkyl group with the number of carbon of 1 to 6), and anion consisting of PF6-, BF4-, ClO4-, N(CF3SO2)₂—, C3SO3-, C(SO2CF3)3-, AsF6- or SbF6-.

As aqueous electrolyte solution, alkaline metal such as sodium and potassium or a proton is used as a cation. As an anion, anion forming together with proton an inorganic acid such as sulfuric acid, nitric acid, hydrochloric acid, phosphoric acid, tetrafluoroborate, hexafluorophosphate, and hexafluorosilicate, and an organic acid such as saturated monocarboxylic acid, aliphatic carboxylic acid, oxycarboxylic acid, para-toluenesulfonic acid, polyvinyl sulfonic acid, and lauric acid is listed.

An electrochemical device of the present invention will be described below.

### (Secondary Battery)

A secondary battery may be prepared as following. In the case of lithium secondary battery, a non-aqueous electrolyte solution dissolving lithium salt as a solute is used as an electrolyte solution. And, an electrode material by a method of the present invention is used as a positive electrode, and an electrode material occluding and releasing lithium such as lithium metal or carbon capable of occluding and releasing lithium is used as a negative electrode. The secondary battery may also be produced by using the electrode material of the present invention for the negative electrode, and using lithium metal oxide such as LiCoO₂ for the positive electrode. In any cases, output characteristics and energy density are improved.

When forming a proton battery, acid aqueous solution having proton as an electrolyte solution is used. And an electrode material of the present invention is used as a positive electrode and the negative electrode of the proton battery such as quinoxaline based polymer is used as a negative electrode. The above proton battery is high in energy density.

### (Double Electric Layer Capacitor)

A double electric layer capacitor may be prepared as following. All of the above non-aqueous type and aqueous type may be used as an electrolyte solution. When using the electrode material by the method of the present invention for a positive electrode and using an electrode having double electric layer capacity such as activated carbon for a negative electrode, this double electric layer capacitor improves in energy density. Also when using an electrode having the double electric layer capacitor for a positive electrode and using the negative electrode of the present invention as a negative electrode, such as activated carbon for a negative electrode, this double electric layer capacitor improves in energy density in the same way.

### (Electrochemical Capacitor)

An electrochemical capacitor may be prepared as following. As an electrolyte solution, a non-aqueous electrolyte solution dissolving quaternary ammonium salt or quaternary phosphonium salt as a solute is used. When using the electrode material by the method of the present invention for a positive electrode and using a conductive polymer such as polythiophene having oxidation-reduction reaction responsiveness for a negative electrode, or when using metal oxide such as the conductive polymer or ruthenium oxide as the positive electrode and using the negative electrode of the present invention as a negative electrode, energy density improves. Further, the polymer complex electrode by the method of the present invention may be used for both positive and negative electrodes, therefore the electrode of the present invention may be used for both electrodes, thereby that allows a electrochemical capacitor having high energy density to be obtained.

### EXAMPLE

The present invention will be further specifically described below using an example.

By using an acetonitrile solution containing Ni(salen) of 1 mM and TEABF4 of 0.1M as an electrolyte solution for electrolysis, and using as electrodes an activated carbon tissue (project area is 1 cm² and specific surface area is 2500 m²g⁻¹) for a work electrode, a silver/silver ion (Ag/Ag+) electrode for a reference electrode, and an activated carbon tissue (project area is 10 cm² and specific surface area is 2500 m²g⁻¹) for a counter electrode, an electrochemical cell is structured, and then a pulse electro polymerization is performed in conditions of a potential of examples 1 to 3 and comparative examples 1 to 3, an amount of polymerization electric charge of 0.5 Ccm⁻², electrolysis time of 1 second, and downtime of 30 second shown in Table 1. After polymerization, the work electrode is cleaned with acetonitrile and dried. Then, the electrochemical cell including electrolyte solution for capacity estimation is structured using these electrodes, the capacity is calculated from cyclic voltammetry and energy is shown in Table 1.

Comparative examples are carried out by a constant potential electro polymerization.

TABLE 1
Constant potential electro polymerization

| | | | | polymerization | energy |
|---|---|---|---|---|---|
| | | | electrolyte | charge/V | (mJ |
| | negative electrode | positive electrode | solution | vs. Ag/Ag+ | cm⁻²) |
| Example 1 | lithium metal | activated carbon | LiClO4-PC | 0.8 | 142 |
| | | electrode/ | | 0.7 | 155 |
| | | poly[Nisaltmen]complex | | | |
| Example 2 | activated carbon | activated carbon | TEABF4-MeCN | 0.8 | 110 |
| | | electrode/ | | 0.7 | 120 |
| | | poly[Nisaltmen]complex | | | |
| Example 3 | activated carbon | activated carbon | TEABF4-MeCN | 0.8 | 128 |
| | electrode/ | electrode/ | | 0.7 | 140 |
| | poly[Nisaltmen]complex | poly[Nisaltmen]complex | | | |
| Comparative | lithium metal | activated carbon | LiClO4-PC | 0.8 | 95 |
| example 1 | | electrode/ | | 0.7 | 125 |
| | | poly[Nisaltmen]complex | | | |
| Comparative | activated carbon | activated carbon | TEABF4-MeCN | | 33 |
| example 2 | (10 μm) | (10 μm) | | | |
| Comparative | activated carbon | activated carbon | TEABF4-MeCN | 0.8 | 85 |
| example 3 | electrode/ | electrode/ | | 0.7 | 112 |
| | poly[Nisaltmen]complex | poly[Nisaltmen]complex | | | |

As described above, an electrochemical device of the present invention shows high energy compared to comparative examples.

1. A method for producing an electrode material, wherein the method comprising the steps of:
1) immersing a conductive material having a specific surface area of 200 to 3000 m²g⁻¹ in a complex monomer solution of a transition metal having at least two different oxidation numbers,
2) performing electro polymerization by applying pulse voltage using the conductive material as an electrode to stack the complex monomer under the condition that electrolyzation time is 0.1 to 60 second and a downtime is 10 to 600 second, and,
3) forming an energy storage redox polymer layer comprising of the stacked complex monomer and including polymer complex compound of the transition metal on the conductive material surface so as to store energy through redox reaction.

2. The method for producing the electrode material a according to claim 1, wherein the pulse voltage is 0.5 to 1.0V vs. Ag/Ag+.

3. The method for producing the electrode material according to claim 1, wherein the number of cycle is 100 to 10000 cycles.

4. The method for producing the electrode material according to claim 1, wherein polymer complex compound of the transition metal is a polymer metal complex of tetra-dentate Schiff's base.

5. The method for producing the electrode material according to claim 4, wherein the polymer metal complex of the tetra-dentate Schiff's base comprises the polymer complex compound represented by the following graphical formula: 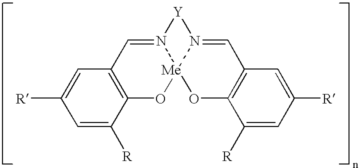
wherein Me is transition metal,
R is H or electron donating substituent,
R′ is H or halogen,
Y is 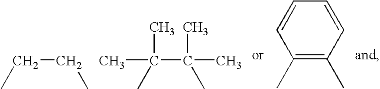
n is an integer number of 2 to 200000.

6. The method for producing the electrode material according to claim 5, wherein the transition metal Me is selected from a group constituted of Ni, Pd, Co, Cu and Fe.

7. The method for producing the electrode material according to claim 5, wherein the R is selected from a group constituted of CH₃O—, C₂H₅O—, HO— and —CH₃.
